(19) United States
(12) Patent Application Publication
(10) Pub. No.: US 2014/0082324 A1
(43) Pub. Date: Mar. 20, 2014

(54) Method and Storage Device for Using File System Data to Predict Host Device Operations

(71) Applicants: Reuven Elhamias, Kefar-vradim (IL); Boris Dolgunov, Ramat-Gan (IL)

(72) Inventors: Reuven Elhamias, Kefar-vradim (IL); Boris Dolgunov, Ramat-Gan (IL)

(21) Appl. No.: 13/618,961

(22) Filed: Sep. 14, 2012

(51) Int. Cl. G06F 12/08

(52) U.S. Cl. 711/213; 711/E12.057

(57) ABSTRACT

A method and storage device for using file system data to predict host device operations are disclosed. In one embodiment, a storage device is disclosed having a first memory storing data and file system metadata, a second memory, and a controller. In response to receiving a command from the host device to read a first address in the first memory, the controller reads data from the first address in the first memory and returns it to the host device. The controller predicts a second address in the first memory to be read by a subsequent read command from the host device, reads the data from the predicted second address, and stores it in the second memory.

### BACKGROUND

Some non-volatile storage devices have a block device interface, which is an application program interface that allows block (or sector) access to data stored in the storage device. The host device typically uses a file system (e.g., FAT, NTFS, or EXT3) to provide user-friendly access and management of data. A file system can include information about the addresses where data is stored in the storage device. With such information, the host device can organize the data and provide efficient ways of accessing and updating data. A file system is often tuned for specific needs of the host device and is deeply integrated with the host device's operating system.

Unfortunately, the storage device typically does not have any information about how the file system is managing the data stored in the storage device. So, the storage device responds to a read or write command from a host device by reading or writing data specified by the block address in the command without any knowledge of what the data is or how it relates to other data stored in the storage device. Therefore, the storage device is unable to optimize data handling to fit the needs of the host device's operating system and file system. For example, after several erases and writes to the storage device (e.g., when updating files), data from a file can become fragmented across the storage device instead of being stored in nearby memory sectors. This can lead to an inefficient use of the storage device.

### Overview

Embodiments of the present invention are defined by the claims, and nothing in this section should be taken as a limitation on those claims.

By way of introduction, the below embodiments relate to a method and storage device for using file system data to predict host device operations. In one embodiment, a storage device is disclosed having a first memory storing data and file system metadata, a second memory, and a controller. In response to receiving a command from the host device to read a first address in the first memory, the controller reads data from the first address in the first memory and returns it to the host device. The controller then predicts a second address in the first memory to be read by a subsequent read command from the host device, reads the data from the predicted second address, and stores it in the second memory. Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary host device and storage device of an embodiment.

FIG. 2 is another block diagram of an exemplary host device and storage device of an embodiment.

FIG. 3 is a flow chart of a method of an embodiment for using file system data to predict host device operations.

FIG. 4 is another flow chart of a method of an embodiment for using file system data to predict host device operations.

### DETAILED DESCRIPTION OF THE PRESENTLY PREFERRED EMBODIMENTS

### Introduction

The following embodiments relate to a method and storage device for using file system data to predict host device operations. As mentioned above, because a storage device typically does not have any information about how the file system on the host is managing data stored in the storage device, the storage device is unable to optimize data handling. These embodiments recognize that it would be useful if the storage device could understand the host device's file system management to optimize internal storage device memory management and provide better performance to the host. Before turning to these and other embodiments, the following section provides a discussion of exemplary host and storage devices that can be used with these embodiments. Of course, these are just examples, and other suitable types of host and storage devices can be used.

### Exemplary Host and Storage Devices

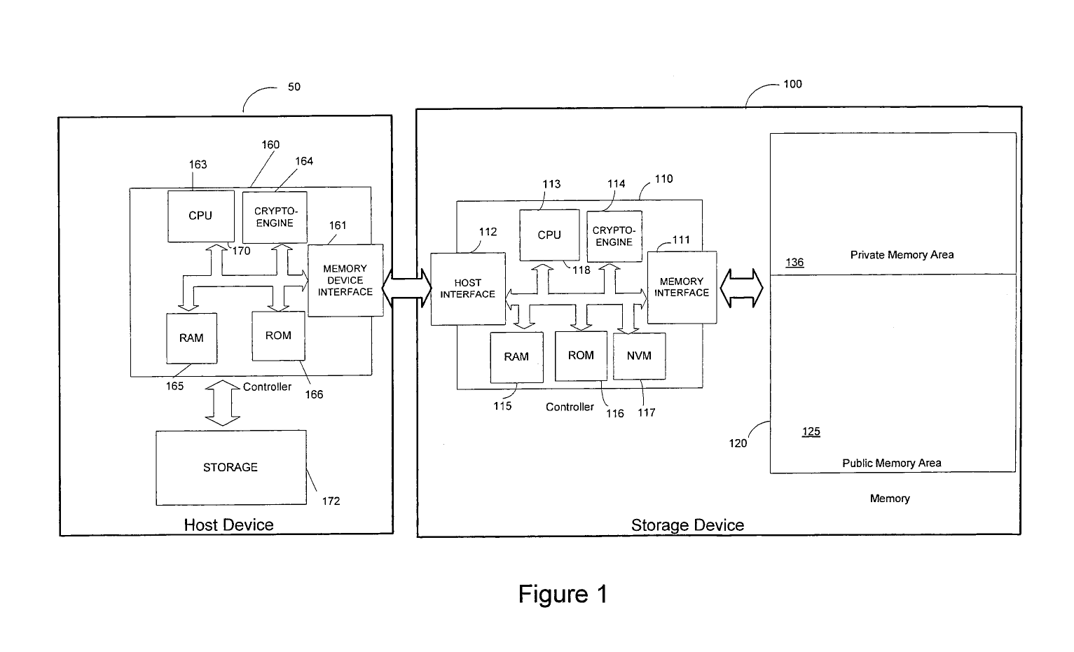

Turning now to the drawings, FIG. 1 is a block diagram of a host device 50 in communication with a storage device 100 of an embodiment. As used herein, the phrase “in communication with” could mean directly in communication with or indirectly in communication with through one or more components, which may or may not be shown or described herein. For example, the host device 50 and storage device 100 can each have mating physical connectors that allow the storage device 100 to be removably connected to the host device 50. The host device 50 can take any suitable form, such as, but not limited to, a mobile phone, a digital media player, a game device, a personal digital assistant (PDA), a personal computer (PC), a kiosk, a set-top box, a TV system, a book reader, or any combination thereof. In this embodiment, the storage device 100 is a mass storage device that can take any suitable form, such as, but not limited to, an embedded memory (e.g., a secure module embedded in the host device 50) and a handheld, removable memory card, as well as a universal serial bus (USB) device and a removable or non-removable hard drive (e.g., magnetic disk or solid-state or hybrid drive). In one embodiment, the storage device 100 takes the form of an iNAND™ eSD/eMMC embedded flash drive by SanDisk Corporation.

As shown in FIG. 1, the storage device 100 comprises a controller 110 and a memory 120. The controller 110 comprises a memory interface 111 for interfacing with the memory 120 and a host interface 112 for interfacing with the host 50. The controller 110 also comprises a central processing unit (CPU) 113, a hardware crypto-engine 114 operative to provide encryption and/or decryption operations, read access memory (RAM) 115, read only memory (ROM) 116 which can store firmware for the basic operations of the storage device 100, and a non-volatile memory (NVM) 117 which can store a device-specific key used for encryption/decryption operations. The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Suitable controllers can be obtained from Marvell or SandForce. The controller 110 can be used to implement the methods shown in the flowcharts and described below.

The memory 120 can take any suitable form. In one embodiment, the memory 120 takes the form of a solid-state (e.g., flash) memory and can be one-time programmable, few-time programmable, or many-time programmable. However, other forms of memory, such as optical memory and magnetic memory, can be used. In this embodiment, the memory 120 comprises a public memory area 125 that is managed by a file system on the host 50 and a private memory area 136 that is internally managed by the controller 110. The private memory area 136 can store data, such as but not limited to content encryption keys (CEKs) and firmware (FW) code. The public memory area 125 can store user data and other data. The public memory area 125 and the private memory area 136 can be different partitions of the same memory unit or can be different memory units. The private memory area 136 is “private” (or “hidden”) because it is internally managed by the controller 110 (and not by the host's controller 160).

Turning now to the host 50, the host 50 comprises a controller 160 that has a storage device interface 161 for interfacing with the storage device 100. The controller 160 also comprises a central processing unit (CPU) 163, an optional crypto-engine 164 operative to provide encryption and/or decryption operations, read access memory (RAM) 165, read only memory (ROM) 166, a security module 171, and storage 172. The storage device 100 and the host 150 communicate with each other via a storage device interface 161 and a host interface 112. For operations that involve the secure transfer of data, it is preferred that the crypto-engines 114, 164 in the storage device 100 and host 150 be used to mutually authenticate each other and provide a key exchange. After mutual authentication is complete, it is preferred that a session key be used to establish a secure channel for communication between the storage device 150 and host 100. Alternatively, crypto-functionality may not be present on the host side, where authentication is done only using a password. In this case, the user types his password into the host device 50, and the host device 50 sends it to the storage device 100, which allow access to the public memory area 125. The host 50 can contain other components (e.g., a display device, a speaker, a headphone jack, a video output connection, etc.), which are not shown in FIG. 1 to simplify the drawings. Of course, in practice, the host device 50 and storage device 100 can have fewer or different components than the ones shown in the figure.

In some environments, the host device 50 is operable to render content stored in the storage device 100. As used herein, “content” can take any suitable form, including, but not limited to, a song, a movie, a game, an application (“app”), a game installer, etc. Depending on the type of content, “render” can mean playing (e.g., when the content is a song or movie), deciphering (e.g., when the content is a game installer), or whatever action is needed to “enjoy” the content. In some embodiments, the host device 50 contains the necessary software to render the content (e.g., a media player), whereas, in other embodiments, such software is provided to the host device 50 by the memory device 100 or another entity.

### Embodiments Related to Using File System Data to Predict Host Device Operations

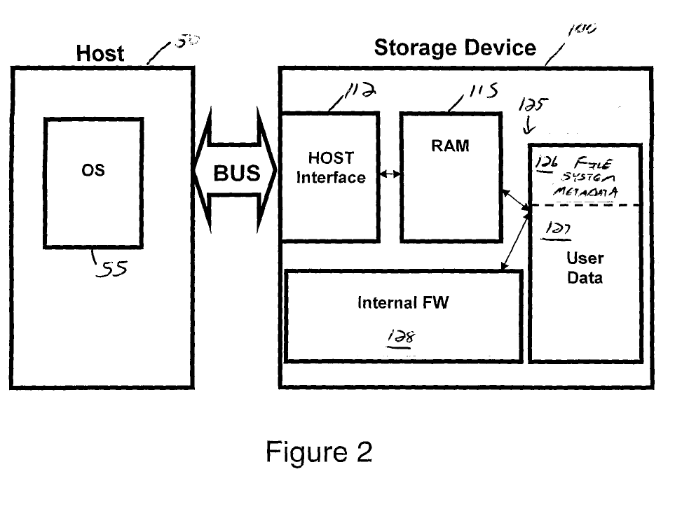

Returning to the drawings, FIG. 2 shows some of the components shown in FIG. 1 to illustrate one example of this embodiment. As shown in FIG. 2, the host device 50 stores an operating system (OS) 55 that implements a file system, such as, for example, the FAT32 file system. (While the FAT32 file system is being used in this example, it should be understood that other files systems (e.g., other FAT file systems, the NTFS file system, and the EXT3 or EXT4 file system) can be used.) In the FAT32 file system, the host device 50 stores both file system metadata 126 and user data 127 in the public memory area 125 of the storage device's memory. The file system allocates the first sectors of the public memory area 125 for file system metadata 126. The file system metadata 126 includes such information as the boot sector, the file system information block, the file system allocation table (FAT), and the directory table. Other or additional information can be stored therein, as specified by the file system being used.

In operation, the host device 50 reads the file system metadata 126 from the storage device 100 and uses this metadata 126 to find the physical locations of data belonging to files stored in the storage device 100, as well as the allocation of free space in the user area that can be used to store additional files. When a user of the host device 50 requests a file stored on the storage device 100, the host device 50 locates the addresses of the sectors of the file from the metadata 126 and then sends several read commands (each with a different address) to read all of the data sectors that make up the file. When the storage device 100 receives a read command, it fetches the sector of data specified by the address in the command. Instead of sending the data directly to the host device 50, the storage device 100 can store the data in its internal RAM 115 for data processing. For example, the storage device 100 can perform error detection and correction on the data, decrypt the data (if it is stored in encrypted form), encrypt (or re-encrypt) data before it is sent to the host device 50, or perform other actions specified by the memory management system of the storage device 100. After the storage device 100 completes its processing of the data, it sends the data from the RAM 115 to the host device 50 via the interface 112. Similarly, when data is sent to the storage device 100 for storage, the data may be first stored in the RAM 115 to perform data processing (e.g., generating an error correction code, encrypting the data, etc.) before the data is stored in the memory.

This embodiment recognizes that it would be useful if the storage device 100 could understand the host device's file system management to optimize internal storage device memory management and provide better performance to the host device 50. Specifically, this embodiment takes advantage of the fact that a given file system specifies where the file system metadata is to be stored (e.g., in the FAT32 file system, the file system metadata is stored in the first sectors of the user area). The controller 110 in the storage device 100 can run firmware 128 to read and parse this file system metadata 126 in an attempt to predict the sectors that the host device 50 will likely read next. This parsing can be done in a similar way as the host device 50 parses the file system metadata 126. However, since the controller 110 is typically more resource limited than the host device's controller, the controller 110 may not be able to parse the metadata as extensively as the host device's controller. However, with currently-available storage device controller technology, the controller 110 can extract some information from the file system metadata 126 for memory management optimization purposes, as will be discussed below.

By parsing the file system metadata 126 to predict which sectors the host device 50 will likely read next, the storage device 100 can “pre-fetch” data that it thinks the host device will need and store the data in RAM 115 (and even start the processing of the data when in RAM 115). That way, if the host device 50 later, in fact, sends a read command for the pre-fetched sector, the data will be ready to be provided to the host device 50 faster than if the pre-fetch did not occur. In one embodiment, the controller 110 performs the file system metadata parsing and pre-fetching data while the data from the previous read command is being processed in RAM 115 and/or while the storage device 100 is waiting for the host device 50 to send the next command.

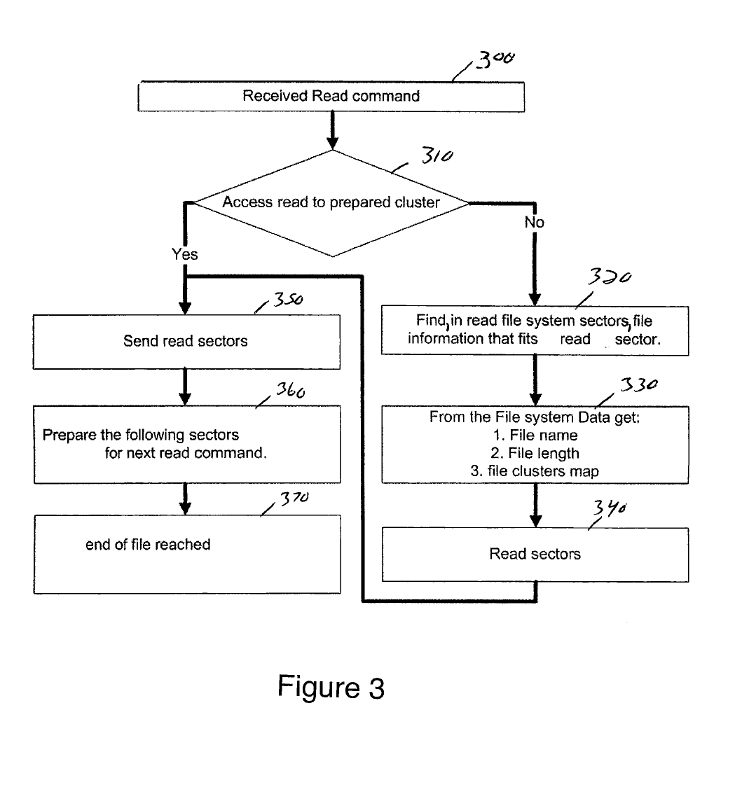

Turning again to the drawings, FIG. 3 is a flow chart of a method for using file system data to predict host device operations. This method can be performed using the storage device's controller 110 (e.g., executing the firmware 128 internally stored in the storage device 100). In a typical host read, the host device 50 first accesses the file system metadata 126 stored in the storage device 100 to locate the physical address of file data (this can be done using a number of block read commands). The controller 110 can detect an access to the file system metadata 126 based on the address in the read command. For example, the controller 110 can compare received read addresses to known addresses of the file system metadata (these addresses can be known because they are specified in the file system specifications). Then, the host device 50 sends a read command to the storage device 100, where the read command specifies the physical address of the file data specified in the file system metadata 126.

When the storage device 100 receives the read command from the host device 50 (act 300), the controller 110 in the storage device 100 determines if the read is for a prepared cluster of sectors (act 310). A “prepared cluster of sectors” is a set of sectors that were previously identified by parsing the file system metadata 126. (Typically, a file system operates with data units called clusters, where every cluster can include one or more sectors. For simplicity, the term “sector,” as used herein, can refer to a single sector, a part of a cluster, a full cluster, or multiple clusters.) If the read command is not for a prepared cluster, the relevant file system metadata 126 has not yet been parsed and a next-accessed sector has not yet been predicted. So, in addition to executing the read command, the controller 110 takes the opportunity to collect and parse the relevant file system metadata 126 to predict what the next-accessed sector will be. Specifically, the controller 110 in the storage device 100 attempts to find, in the file system sectors that hold the file system metadata 126, the information that fits the read sector (act 320). The controller 110 can search the file system metadata 126 for the address specified in the read command and then parse the metadata 126 for information, such as, but not limited to, the file name, the file length, and the file cluster map (act 330). As will be explained in more detail below, with this information, the controller 110 can predict which sectors the host device 50 will want to read next and pre-fetch the data. Next, the controller 110 reads the sectors requested by the read command from the host device 50 (act 340). As discussed above, these read sectors can be stored in RAM 115 for processing before sending them to the host device 50.

Next, the read sectors are sent to the host device (act 350). Before, during, or after that act, the controller 110 can prepare the next sectors specified by the file system metadata 126 for the next read command (act 360). For example, if the file system metadata 126 indicates that a certain file is stored in sectors 2, 5, 4, 1, and 3 (in that order), and the host device 50 requested a read of sector 2, by parsing the file system metadata 126, the controller 110 can predict that sector 5 is the next sector that the host device 50 will want to read (because sector 5 is the next sector in the file). So, during the processing (e.g., error correction, decryption, etc.) of the data from sector 2 or while waiting for the next command from the host device 50, for example, the controller 110 can read the data from sector 5 and store it in RAM 115 so it is ready to go when the host device 50 requests it.

So, going back to the top of the flow chart, if the host device 50 later requests to read sector 5 (act 300), the controller 110 would know that sector 5 was in the prepared cluster (act 310) and would return the data from sector 5 to the host device 50 (act 350). Again, this improves performance of the storage device 100 because the requested data is ready to be sent to the host device 50 upon receipt of the read command for the data (or at the very least, the data is already read from memory, even if the processing of the data is not yet finished). The controller 110 then looks for the next sector to pre-fetch (in this example, sector 4) (act 360), and the process described above repeats until the end of the file is reached (in this example, until sector 3 is read) (act 370). If it turns out that the controller's prediction is incorrect and the host device 50 requests a sector different from the pre-fetched one, the data stored in RAM 115 from the pre-fetched sector can be discarded.

There are several advantages associated with this embodiment. For example, by predicting and pre-fetching the next read sector, this embodiment can provide better performance of the storage device 100. For example, as noted above, storing the data from the predicted address in RAM 115 reduces the time needed to retrieve and return the data to the host device 50. This embodiment also allows this benefit to be realized without any modification to the host device 50 (e.g., no special host operations are needed), and the memory device 100 does not need to store any additional information about the data, as all of the information needed is contained in the conventional file system metadata 126.

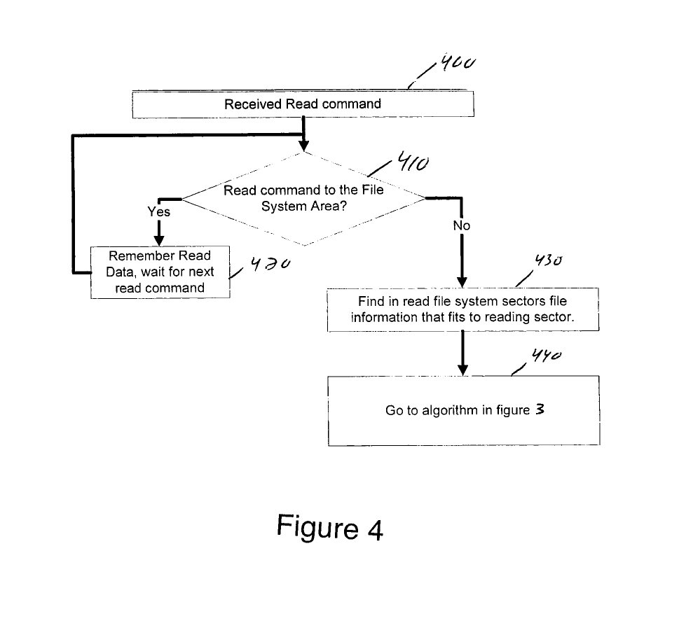

There are several alternatives that can be used with these embodiments. For example, the prediction algorithm can be improved by taking into account the sectors read previous to the data access. The controller 110 can be configured to remember the sectors read by the host device 50 and can limit the search in file system metadata 126 to the read sectors. Especially interesting is the last sector that was read. Since access to the storage device 100 is done in resolution of sectors, the firmware 128 may not be able to determine exactly which file is accessed, but this information can significantly decrease search time. So, with reference to FIG. 4, when the storage device 100 receives a read command (act 400), the controller 110 can determine whether the read command is to the file system area of memory (act 410). If it is, the controller 110 can remember the read data and wait for the next read command (act 420). When the next read command that is not to the file system area is received, the controller 110 can fing the read file system sector file information that fits the reading sector (act 430) and the proceed to the algorithm shown in FIG. 3 (act 440). This alternative can be used to improve the search algorithm for the file name, the file length, and the cluster map, especially when the file system area is large and it would take a long time for the controller 11 to search for the correct file system information.

As another alternative, these embodiments can be used for write commands in addition to or instead of read commands. During a write operation, the host device 50 looks for the free space. After the first write operation, the controller 110 can parse the file system metadata 126 and detect if the next cluster is free. If the next cluster is not free, the controller 110 can find the next available cluster and prepare the write operation prior to the receiving of write command from the host device.

In another alternative embodiment, instead of or in addition to using the predicted next address to pre-fetch data to be returned to the host device 50, the controller 110 can use the knowledge of the predicted next address to adjust and optimize a memory management function, such as, but not limited to, garbage collection, read scrubbing, compaction, folding, updating a translation table update, and wear leveling. For example, the controller 110 can avoid performing a memory management function (e.g., wear leveling) on an address that will be accessed in the near future. As another example, based on the knowledge of the predicted address, the controller 110 can perform garbage collection to make the retrieval of the data from the predicted address faster.

As yet another alternative, these embodiments can be used to manage security file properties. For example, if the storage device 100 includes a secure platform that allows protection of files (e.g., the TrustedFlash™ platform by SanDisk Corporation), this embodiment can be used to locate the appropriate key to decrypt requested data after access to the data is granted. More specifically, when a file is accessed, the secure platform can use this embodiment to calculate the file name according to every read operation. The key is bound to a specific file name, and, if access is allowed to the specific file, the secure platform can decrypt the content with corresponding key and send the decrypted content to the host device 50. So, this alternative avoids the need for the host device 50 to send a special command to the storage device 100 to indicate which key to use to decrypt the file because the controller 110 can use the file system information to determine which key should be used to decrypt the file.

### Conclusion

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A storage device comprising:
a host device interface through which the storage device can communicate with a host device;
a first memory storing data and file system metadata;
a second memory; and
a controller in communication with host device interface and the first and second memories, wherein the controller is configured to perform the following:
in response to receiving a command from the host device to read a first address in the first memory:
read data from the first address in the first memory and return it to the host device;
predict a second address in the first memory to be read by a subsequent read command from the host device, wherein the second address is predicted using the file system metadata and the first address; and
read the data from the predicted second address and store it in the second memory.

2. The storage device of claim 1, wherein the controller is further configured to:
in response to receiving a command from the host device to read the second address in the first memory:
return the data stored in the second memory instead of reading the second address in the first memory.

3. The storage device of claim 1, wherein the controller is further configured to store the data read from the first address in the second memory before returning the data to the host device.

4. The storage device of claim 3, wherein the data is processed before it is returned to the host device.

5. The storage device of claim 1, wherein the controller is further configured to use the predicted second address to perform a memory management function.

6. The storage device of claim 5, wherein the memory management function comprises one or more of the following: garbage collection, read scrubbing, compaction, folding, updating a translation table update, and wear leveling.

7. The storage device of claim 1, wherein the data is encrypted, and wherein the controller is further configured to use the predicted second address to locate a key to decrypt the data.

8. The storage device of claim 1, wherein the controller is further configured to, in response to receiving a write command from the host, predict an address and determine if the predicted address to available to be written into.

9. The storage device of claim 1, wherein the controller is configured to perform the predicting act without needed a special command from the host device.

10. A method for using file system metadata to predict an address, the method comprising:
performing the following in a storage device having a first memory storing data and file system metadata and a second memory:
in response to receiving a command from the host device to read a first address in the first memory:
reading data from the first address in the first memory and returns it to the host device;
predicting a second address in the first memory to be read by a subsequent read command from the host device, wherein the second address is predicted using the file system metadata and the first address; and
reading the data from the predicted second address and stores it in the second memory.

11. The method of claim 10 further comprising:
in response to receiving a command from the host device to read the second address in the first memory:
returning the data stored in the second memory instead of reading the second address in the first memory.

12. The method of claim 10 further comprising storing the data read from the first address in the second memory before returning the data to the host device.

13. The method of claim 12 further comprising processing the data before it is returned to the host device.

14. The method of claim 10 further comprising using the predicted second address to perform a memory management function.

15. The method of claim 14, wherein the memory management function comprises one or more of the following: garbage collection, read scrubbing, compaction, folding, updating a translation table update, and wear leveling.

16. The method of claim 10, wherein the data is encrypted, and wherein the method further comprises using the predicted second address to locate a key to decrypt the data.

17. The method of claim 10 further comprising in response to receiving a write command from the host, predicting an address and determines if the predicted address to available to be written into.

18. The method of claim 10, wherein the predicting is performed without needed a special command from the host device.
